(19) United States
(12) Patent Application Publication
(10) Pub. No.: US 2017/0131310 A1
(43) Pub. Date: May 11, 2017

(54) SAMPLE CONTAINER CARRIER, LABORATORY SAMPLE DISTRIBUTION SYSTEM AND LABORATORY AUTOMATION SYSTEM

(71) Applicant: Roche Diagnostics Operations, Inc., Indianapolis, IN (US)

(72) Inventors: Henny Volz, Boenigheim (DE); Michal Malinowski, Backnang (DE); Hans Schneider, Schwaikheim (DE); Christian Riether, Muehltal (DE)

(21) Appl. No.: 15/405,689

(22) Filed: Jan. 13, 2017

Related U.S. Application Data
(63) Continuation of application No. PCT/EP2015/066798, filed on Jul. 22, 2015.

(30) Foreign Application Priority Data
Jul. 23, 2014 (EP) 14178221.9

(51) Int. Cl. G01N 35/04

(52) U.S. Cl. CPC G01N 35/04; G01N 2035/0477

(57) ABSTRACT

A sample container carrier for a laboratory sample distribution system having a cover above a magnet in order to suitably align magnetic field lines is presented. A laboratory sample distribution system having such a sample container carrier and to a laboratory automation system containing such a laboratory sample distribution system are also presented.

### CROSS-REFERENCE TO RELATED APPLICATIONS

This application is a continuation of PCT/EP2015/066798, filed Jul. 22, 2015, which is based on and claims priority to EP 14178221.9, filed Jul. 23, 2014, which is hereby incorporated by reference.

### BACKGROUND

The present disclosure relates to a sample container carrier for a laboratory sample distribution system, to a laboratory sample distribution system comprising such a sample container carrier, and to a laboratory automation system comprising such a laboratory sample distribution system.

Laboratory sample distribution systems comprising sample container carriers are typically used for laboratory automation systems. Such laboratory automation systems may comprise laboratory stations like pre-analytical, analytical and/or post-analytical stations.

An example for such a laboratory sample distribution system comprises a transport plane and a plurality of electro-magnetic actuators positioned below the transport plane. It further comprises a number of sample container carriers, being adapted to carry sample containers. Such sample containers can, for example, be tubes made of transparent material.

A carrier transport device having a stator table comprised of a plurality of stators and a carrier with a plurality of permanent magnets is known. The carrier comprises a plate affixed to a surface of a carrier body comprised of magnetically-conductive material.

A container carrier comprising a magnetically active device is also known. The sample container carriers comprise a sliding member adapted to be in contact with a transport plane.

However, there is a need for a sample container carrier, a laboratory sample distribution system and a laboratory automation system that is energy efficient and reliable.

### SUMMARY

According to the present disclosure, a sample container carrier for a laboratory sample distribution system is presented. The sample container carrier can be adapted to carry one or more sample containers and can be adapted to be moved over a transport plane of the laboratory sample distribution system. The sample container carrier can comprise a magnetically active device adapted to interact with a magnetic field generated by the laboratory sample distribution system such that a magnetic move force is applied to the sample container carrier and a ferromagnetic cover covering the magnetically active device. The cover can be adapted to align and concentrate magnetic field lines originating from the magnetically active device such that a magnetic field line density is increased in a direction towards the transport plane.

Accordingly, it is a feature of the embodiments of the present disclosure to provide for a sample container carrier, a laboratory sample distribution system and a laboratory automation system that is energy efficient and reliable. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIGS. 1a-b illustrates a sample container carrier in exploded views according to an embodiment of the present disclosure.

FIG. 2 illustrates the sample container carrier in a sectional view according to an embodiment of the present disclosure.

FIG. 3 illustrates the sample container carrier in a perspective sectional view according to an embodiment of the present disclosure.

FIG. 4 illustrates the sample container carrier in a perspective top view according to an embodiment of the present disclosure.

FIGS. 5a-b illustrates a permanent magnet with respective field lines without and with a cover according to an embodiment of the present disclosure.

FIG. 6 illustrates a laboratory automation system comprising a laboratory sample distribution system, the laboratory sample distribution system comprising the sample container carrier according to an embodiment of the present disclosure.

FIG. 7 illustrates a sample container carrier in a sectional view according to another embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A sample container carrier for a laboratory sample distribution system is presented. The sample container carrier can be adapted to carry one or more sample containers such as, for example, in the form of conventional sample tubes. The sample container carrier can further be adapted to be moved over a, e.g. horizontal, transport plane of the laboratory sample distribution system.

The sample container carrier can comprise a magnetically active device adapted to interact with a magnetic field generated by the laboratory sample distribution system such that a magnetic move force can be applied to the sample container. It can be understood that the sample container carrier can comprise a plurality of magnetically active devices, e.g. in order to introduce a preferred orientation in the sample container carrier. The magnetically active device can be a permanent magnet, an electromagnet, and/or be made of or comprise ferromagnetic material.

The sample container carrier can further comprise a cover covering the magnetically active device. The cover may be made of, or comprise, a material having a relative permeability μr larger than 1, preferably larger than 10, preferably larger than 100, preferably larger than 1000, preferably larger than 10000. The cover may be made of or comprise ferromagnetic or ferrimagnetic material. The cover may be made of, or comprise, a magnetically soft material, preferably construction steel. This material has been proven to show suitable properties for the intended use and is cheap and easily available. The cover can, for example, have a dome shape, which has been proven suitable for the intended use.

The cover can align and concentrate magnetic field lines originating from the magnetically active device such that a magnetic field line density can be increased in a desired direction towards the transport plane, where the magnetic field of the magnetically active device is intended to interact with the magnetic field generated by the laboratory sample distribution system. This can allow for reduced electric power consumption when driving the sample container carriers over the transport plane.

According to an embodiment, the magnetically active device and/or the cover can be vertically aligned with a bottom of the sample container carrier.

According to an embodiment, the sample container carrier can comprise a sliding member. The sliding member can be adapted to be in contact with the transport plane if the sample container carrier is placed on the transport plane. The cover and the sliding member can define a, e.g. closed, cavity. The magnetically active device can be arranged inside the cavity. The sample container carrier can slide on the transport plane on its sliding member. The sliding member may be adapted such that friction between the transport plane and the sliding member can be reduced.

According to an embodiment, the cover can have an opening or can be open in the direction of the sliding member. This can allow for an outlet of magnetic field lines towards the transport plane, especially when the magnetically active device is placed under the cover and above the sliding member.

The magnetically active device and/or the cover may have a substantially circular cross-section in a horizontal direction. The term “horizontal” can refer to a typical orientation of the sample container carrier in use. Thus, a preferred orientation of the sample container carrier may be omitted.

According to an embodiment, the cover can comprise a plate positioned above the magnet. The plate can extend laterally beyond the magnetically active device. This can allow for a shielding of magnetic field lines above the magnet.

According to an embodiment, the cover at least partially can laterally surround the magnetically active device. This can allow for a shield or field guiding all around the magnetically active device. Alternatively, the cover may comprise a number of sectors laterally surrounding the magnetically active device. The sectors can be distant from each other. Such an embodiment can allow for a preferred orientation or a plurality of preferred orientations. For example, the cover may comprise between two and ten sectors.

According to an embodiment, laterally surrounding portions of the cover can be distant from the magnetically active device. This can allow for a dedicated bending of magnetic field lines leaving the magnetically active device at its upper side.

According to an embodiment, laterally surrounding portions of the cover and/or portions of the cover positioned above the magnet can have a thickness adapted to prevent magnetic saturation at typical magnetic fields induced by the magnetically active element. Such typical magnetic fields can, for example, have a value of about 0.7 T. Saturation can lead to a decreased capacity of the cover to bend the magnetic field lines as intended.

According to an embodiment, portions of the cover positioned above the magnet can, at least partially, abut the magnetically active device. This can lead to an increased coupling of magnetic field lines from the magnetically active device to the cover. For example, the cover can abut the magnetically active device with the plate discussed above.

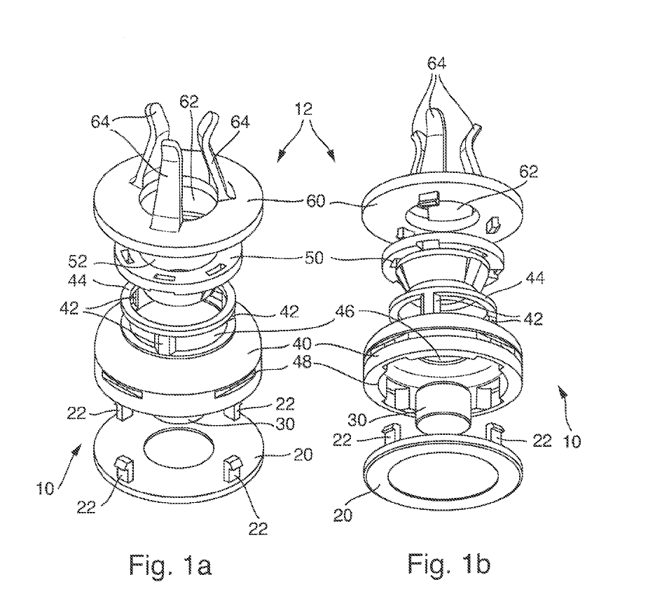

Referring initially to FIG. 1, FIGS. 1a-b show a sample container carrier 10 according to one embodiment. FIG. 1a shows the sample container carrier 10 in an exploded view from above, whereas FIG. 1b shows the sample container carrier 10 in an exploded view from below.

A sliding member 20 can be arranged at the bottom of the sample container carrier 10. The sliding member 20 can be embodied as a disk that can slide over a transport plane of a laboratory sample distribution system. The sliding member 20 can comprise four posts 22 extending to the upper side. The posts 22 can be intended for attaching further elements of the sample container carrier 10.

Above the sliding member 20, a magnetically active device in form of a permanent magnet 30 can be arranged. The permanent magnet 30 can be made of a hard ferromagnetic material and can be permanently magnetized such that it can generate a magnetic field similar to a coil having a vertical axis.

Above the magnet 30, a cover 40 can be arranged, which can be made of a soft ferromagnetic material. The cover 40 can comprise a top plate 46 positioned above the magnet and laterally extending over the magnet, and a laterally surrounding portion 48. The laterally surrounding portion 48 can completely surround the magnet 30, thus omitting a preferred orientation of the sample container carrier 10. The cover 40 can further comprise three posts 42 extending at the top side of the cover 40 and a ring 44 arranged over the posts 42. The posts 42 and the ring 44 can be adapted to mechanically couple to a holder 12 over the cover 40.

The holder 12 can comprise a cone element 50 and a spring element 60. The cone element 50 can be inserted into the ring 44 and can comprise a cone 52 with an inner diameter decreasing from the upper side to the lower side. This cone 52 can laterally hold tube-shaped sample containers with different diameters.

The spring element 60 can be embodied as a disk having a bore 62 in the center of the disk. The bore 62 can be adapted such that a sample container can be put through it. The spring element 60 can further comprise three spring arms 64 positioned around the bore 62. The spring arms 64 can be adapted to laterally engage and thus fix a tube-shaped sample container.

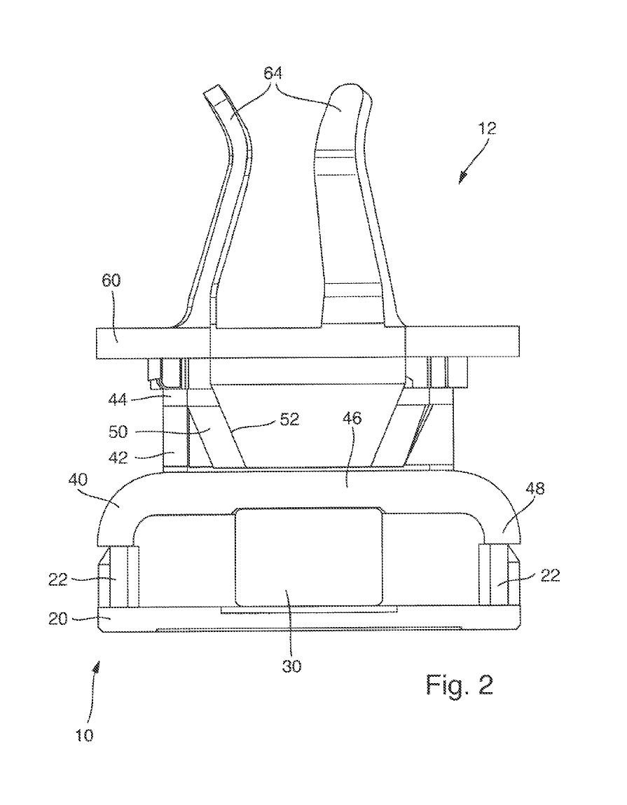

FIG. 2 shows a sectional view of the sample container carrier 10 in an assembled condition. As depicted, the permanent magnet 30 can rest on the sliding member 20. The top plate 46 can rest on the permanent magnet 30. Thus, these elements can be in direct contact. The surrounding element 48 of the cover 40 can laterally surround the permanent magnet 30 with a radial distance.

The cone element 50 and the spring element 60 of the holding means 12 can be positioned just above the cover 40. The posts 22 can affix the sliding element 20. For further details, reference is made to the above description of Figs. la-b.

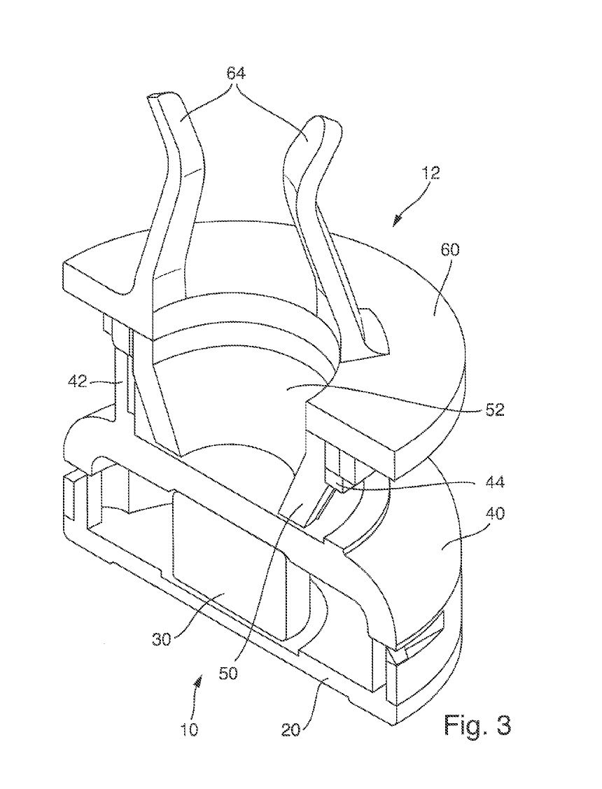

FIG. 3 shows the sample container carrier 10 in another sectional, perspective view. With regard to the elements of the sample container carrier 10, reference is made to the above description of FIGS. 1a-b and 2. As depicted, the cone 52 can provide for a lateral support of a sample container contained in the holder 12.

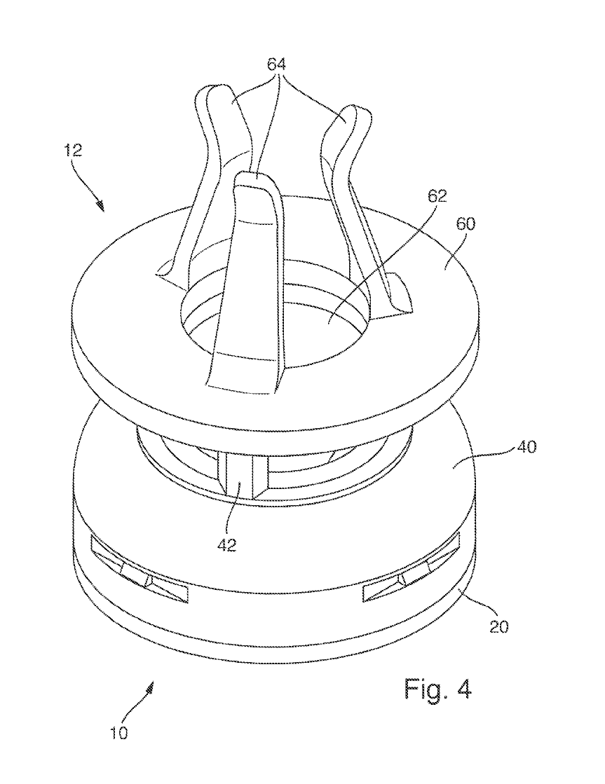

FIG. 4 shows the sample container carrier 10 in an assembled condition and in a perspective view. The sample container carrier 10 can be adapted to move over a transport plane of a laboratory sample distribution system with its sliding member 20 and can be driven by a magnetic field generated by electro-magnetic actuators of the laboratory sample distribution system and interacting with the magnetic field of the permanent magnet 30. The sample container carrier 10 can contain or carry a sample container in the holder 12.

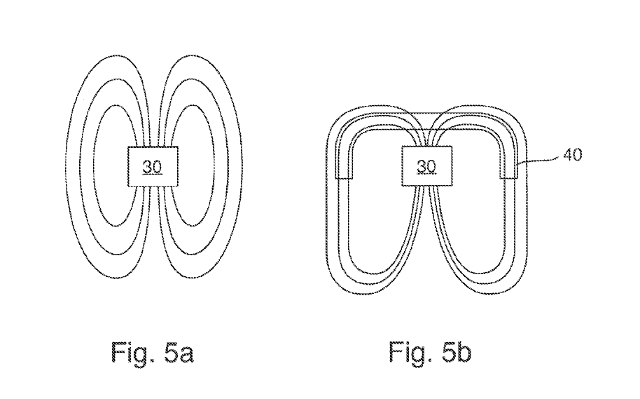

FIGS. 5a-b schematically depict a comparison between magnetic field lines of the permanent magnet 30 with and without the cover 40. FIG. 5a shows the permanent magnet 30 without the cover 40. As depicted, the magnetic field lines generated by the permanent magnet 30 can symmetrically extend to the upper side and to the lower side. FIG. 5b shows the permanent magnet 30 with the cover 40 imposed on it. As depicted, the permanent magnet 30 and the cover 40 together can have the shape of a mushroom. The magnet 30 can form the post.

The magnetic field lines generated by the permanent magnet 30 of FIG. 5b can be guided by the cover 40 such that the magnetic field lines can be concentrated within the cover 40. As a result, a distorting upper and lateral magnetic stray field can be reduced. This can reduce an unwanted magnetic coupling between sample container carriers positioned or moving adjacent to each other on the transport plane. Further, the magnetic flux directed towards the transport plane and the electro-magnetic actuators positioned below the transport plane can be increased, thus increasing the resulting magnetic drive force. Thus, energy consumption of the laboratory sample distribution system can be reduced.

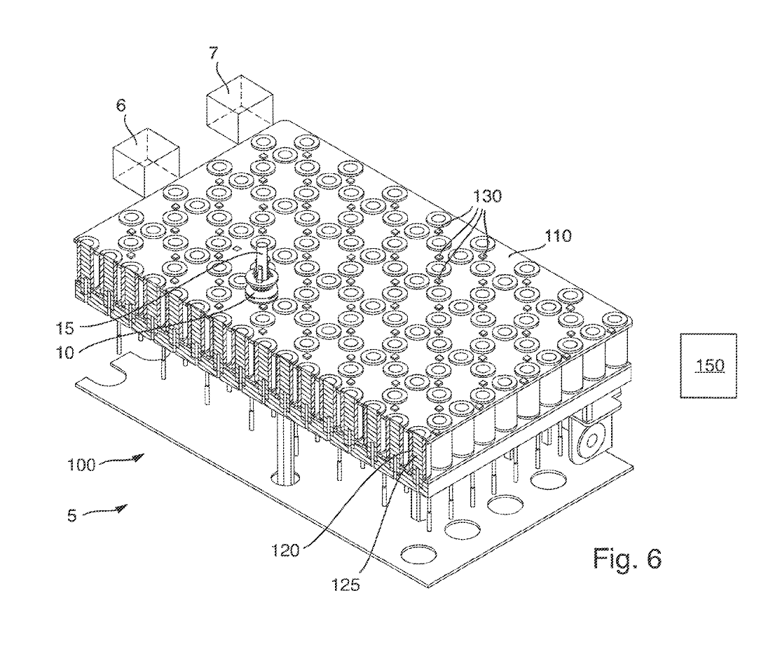

FIG. 6 shows a laboratory automation system 5 comprising a first laboratory station 6, a second laboratory station 7, and a laboratory sample distribution system 100. The laboratory stations 6, 7 can be positioned adjacent to the laboratory sample distribution system 100 so that samples contained in sample containers 10 can be distributed between the laboratory stations 6 and 7 by the laboratory sample distribution system 100.

The laboratory sample distribution system 100 can comprises a transport plane 110, on which sample container carriers 10 can move. In FIG. 6, only one sample container carrier 10 is schematically depicted, wherein it can be noted that typical laboratory sample distribution systems 100 can comprise a plurality of sample container carriers 10. The sample container carrier 10 can contains a sample container 15 adapted to comprise a sample.

A plurality of electro-magnetic actuators 120 can be arranged below the transport plane 110, each comprising a ferromagnetic core 125. The electro-magnetic actuators 120 can be adapted to generate a magnetic field used to move the sample container carriers 10 on the transport plane 110. Further, a plurality of Hall sensors 130 can be positioned on the transport plane 110. The Hall sensors 130 can be adapted to determine a respective position of a sample container carrier 10.

The lateral extension of the sample container carrier 10 can be such that it can extend over an electro-magnetic actuator 120 over which it can be positioned to the edges of respective neighboring electromagnetic actuators. This has been proven to yield high efficiency when moving the sample container carrier 10 over the transport plane 110 by the electro-magnetic actuators 120.

The laboratory sample distribution system 100 can further comprises a control unit 150. The control unit 150 can be adapted to drive the electro-magnetic actuators 120 such that the sample container carrier 10 can move according to a predetermined path.

The control unit 150 can further be connected to the Hall sensors 130 in order to determine the position of each sample container carrier 10. The control unit 150 can direct sample container carriers 10 independent from one another to any laboratory station 6, 7.

Due to the sample container carrier 10 having a ferromagnetic cover 40 covering the permanent magnet 30, energy consumption of the laboratory sample distribution system 100 can be reduced and accuracy of positioning can be increased.

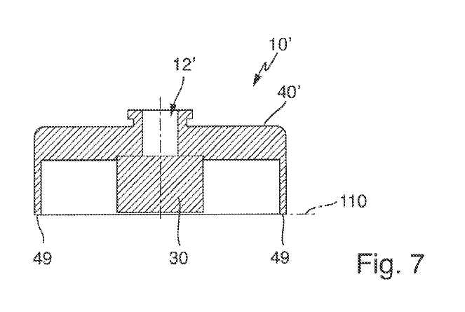

FIG. 7 shows a sample container carrier 10′ according to a further embodiment in a sectional view. The sample container carrier 10′ can comprise the magnetically active device in the form of a permanent magnet 30 and a bell-shaped ferromagnetic cover 40′ formed of electroconductive material, e.g. iron steel. A lower portion 49 of the ferromagnetic cover 40′, defining an opening of the ferromagnetic cover 40′, can be adapted to be in direct contact with the transport plane 110 when the sample container carrier 10′ is placed on the transport plane 110. The ferromagnetic cover 40′ and the transport plane 110 can define a cavity when the sample container carrier 40′ is placed on the transport plane 110. The magnetically active device 30 can be arranged inside the cavity.

The magnetically active device 30 can be fixed to the ferromagnetic cover 40′ at an upper end of the ferromagnetic cover 40′. The ferromagnetic cover 40′ can comprise a holder 12′ for a sample container. The holder 12′ can be embodied as a blind hole in the ferromagnetic cover 40′ having a circular cross section, adapted to receive a sample container.

The transport plane 110 according to this embodiment can be made of electroconductive material and can be grounded. This embodiment can prevent an electrostatic charging of the transport plane 110 and of the sample container carriers 10′ when the sample container carriers 10′ move over the transport plane 110.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A sample container carrier for a laboratory sample distribution system, wherein the sample container carrier is adapted to carry one or more sample containers and is adapted to be moved over a transport plane of the laboratory sample distribution system, the sample container carrier comprises:
a magnetically active device adapted to interact with a magnetic field generated by the laboratory sample distribution system such that a magnetic move force is applied to the sample container carrier; and
a ferromagnetic cover covering the magnetically active device, wherein the cover is adapted to align and concentrate magnetic field lines originating from the magnetically active device such that a magnetic field line density is increased in a direction towards the transport plane.

2. The sample container carrier according to claim 1, further comprising,
a sliding member, wherein the sliding member is adapted to be in contact with the transport plane if the sample container carrier is placed on the transport plane, wherein the cover and the sliding member define a cavity, and wherein the magnetically active device is arranged inside the cavity.

3. The sample container carrier according to claim 2, wherein the cover has an opening in the direction of the sliding member.

4. The sample container carrier according to claim 1, wherein the magnetically active device and/or the cover have a circular horizontal cross section.

5. The sample container carrier according to claim 1, wherein the cover comprises a plate positioned above the magnetically active device and wherein the plate extends laterally beyond the magnetically active device.

6. The sample container carrier according to claim 1, wherein the cover at least partially laterally surrounds the magnetically active device.

7. The sample container carrier according to claim 6, wherein the cover comprises a number of sectors laterally surrounding the magnetically active device, the sectors being distant from each other.

8. The sample container carrier according to claim 1, wherein the cover is cap shaped and imposed on the magnetically active device.

9. The sample container carrier according to claim 1, further comprising, a holder for a sample container.

10. The sample container carrier according to claim 9, wherein the holder comprises an intake element forming a cone, the cone is adapted to guide and partially intake an end portion of the sample container.

11. The sample container carrier according to claim 9, wherein the holder comprises a number of spring arms positioned at the top of the sample container carrier, the spring arms are adapted to fix the sample container.

12. The sample container carrier according to claim 9, wherein the holder is positioned above the cover.

13. A laboratory sample distribution system, the laboratory sample distribution system comprising:
a number of sample container carriers according to claim 1;
a transport plane adapted to support the sample container carriers;
a number of electro-magnetic actuators stationary arranged below the transport plane, the electro-magnetic actuators adapted to generate magnetic fields to move the sample container carriers on top of the transport plane; and
a control device configured to control the movement of the sample container carriers on top of the transport plane by driving the electro-magnetic actuators such that the sample container carriers move along corresponding transport paths.

14. The laboratory sample distribution system according to claim 13, wherein a radius of the cover in a horizontal cross section is identical to or smaller than a minimal distance between a center of an electro-magnetic actuator and a circumference of an adjacent electro-magnetic actuator.

15. A laboratory automation system, laboratory automation system comprising:
a number of laboratory stations; and
a laboratory sample distribution system according to claim 13 adapted to distribute sample container carriers and/or sample containers between the laboratory stations.

16. The laboratory automation system according to claim 15, wherein the number of laboratory stations are pre-analytical stations, analytical stations and/or post-analytical stations.
